(19) United States
(12) Patent Application Publication
(10) Pub. No.: US 2018/0367839 A1
(43) Pub. Date: Dec. 20, 2018

(54) METHOD AND SYSTEM FOR SYNCHRONIZATION OF AUDIO CONTENT FOR A REMOTELY DISPLAYED VIDEO

(71) Applicant: OOHMS NY LLC, New York, NY (US)

(72) Inventor: Alexander VANDOROS, New York, NY (US)

(73) Assignee: OOHMS NY LLC, New York, NY (US)

(21) Appl. No.: 15/666,090

(22) Filed: Aug. 1, 2017

Related U.S. Application Data
(63) Continuation of application No. 15/625,377, filed on Jun. 16, 2017, now abandoned.

(51) Int. Cl. H04N 21/43; H04N 5/765; G11B 27/10; H04N 21/81; H04N 21/233; H04N 21/858; H04N 21/41; H04N 21/439; H04N 21/8547; H04N 21/435

(52) U.S. Cl. CPC H04N 21/4307; H04N 5/765; G11B 27/10; H04N 21/812; H04N 21/8106; H04N 21/233; H04N 21/435; H04N 21/8586; H04N 21/4122; H04N 21/439; H04N 21/8547

(57) ABSTRACT

A method for synchronizing remotely played audio with a video display includes: receiving, by a receiving device of a processing server, a video data file, wherein the video data file includes at least a video stream and an audio stream; extracting, by a decoding module, the audio stream from the received video data file; receiving, by the receiving device of the processing server, a video timestamp, wherein the video timestamp corresponds to a time of the video stream as being displayed by a display device; generating, by a generation module of the processing server, a broadcast message, wherein the broadcast message includes at least the video timestamp, a server time of the processing server, and a response time; and electronically transmitting, by a transmitting device of the processing server, the generated broadcast message to one or more computing devices.

### FIELD

The present disclosure relates to the synchronization of audio content being emitted by a computing device with video that is being remotely displayed on a separate device, specifically the ability for a user computing device to emit audio that is synchronized to a separate video display viewed by the user.

### BACKGROUND

Visual displays have been used for a number of years for a variety of reasons, such as advertisement, notification, or entertainment. Traditionally, visual displays were a form of printed media, such as a poster, billboard, etc., which is static and must be physically replaced over time to update the display. Such a process could be time consuming and physically difficult, such as the replacing of a billboard. Furthermore, a static display may have diminishing returns if exposed to the same audience over time. However, for many years there lacked any ability to improve visual displays to account for these problems.

As technology developed, electronic visual displays became both feasible and economical. Printed displays could be replaced with various type of video displays capable of displaying videos or other forms of visual media that could be easily changed, updated, and could cycle through various content. As a result, many traditional printed displays have been replaced by electronic displays capable of display video and other electronic content.

However, while video content may be useful to reach an audience, in many instances visual content may be more effective when paired with audio content. For example, a commercial advertisement for a product may have significantly less impact on potential customers when not accompanied by an audio explanation of the product. Similarly, an audio jingle or slogan may persist in a customer's mind, and increase the effectiveness of a video display. Unfortunately, many video displays may lack the ability to play accompanying audio. Furthermore, video displays may be in locations that are not conducive to the emission of audio, such as a wall advertisement on a busy street. In an effort to address such problems, some methods have been developed to transmit audio content to a user device possessed by users viewing the video display, such as described in U.S. patent application Ser. No. 14/250,768, entitled “System and Method for Distribution of Audio and Projected Visual Content,” by Alexander Vandoros, filed on Apr. 11, 2014, which is herein incorporated by reference in its entirety. However, without proper synchronization to the video display, audio content that accompanies a video or other visual display may be less than optimal, particularly when there are the potential differences in devices and communication channels involved.

Thus, there is a need for a technical solution to automatically synchronize audio content emitted by a user computing device with a video display that is remotely displayed by a separate device.

### SUMMARY

The present disclosure provides a description of systems and methods for the synchronization of audio played on a computing device with a remotely displayed video. A server maintains information regarding the current position of a video display, using a series of timestamps with respect to the current time of the server. The server notifies user computing devices of the current position of the video display, along with the server time to account for any differences in device times, as well as a response time that can account for latency due to processing and communication. The user computing device can receive the audio signal accompanying the video display, and, using the timing information provided by the server, play the audio signal at the appropriate position to accurately synchronize the audio with the remotely displayed video. As a result, the user can be provided with a better experience whereby the audio content is automatically synchronized to a remotely displayed video.

A method for synchronizing remotely played audio with a video display includes: receiving, by a receiving device of a processing server, a video data file, wherein the video data file includes at least a video stream and an audio stream; extracting, by a decoding module, the audio stream from the received video data file; receiving, by the receiving device of the processing server, a video timestamp, wherein the video timestamp corresponds to a time of the video stream as being displayed by a display device; generating, by a generation module of the processing server, a broadcast message, wherein the broadcast message includes at least the video timestamp, a server time of the processing server, and a response time; and electronically transmitting, by a transmitting device of the processing server, the generated broadcast message to one or more computing devices.

A method for emitting audio synchronized with remotely displayed video includes: electronically transmitting, by a transmitting device of a computing device, a data request to a processing server, wherein the data request includes at least a video identifier; receiving, by a receiving device of the computing device, an audio stream; receiving, by the receiving device of the computing device, a broadcast message from the processing server, wherein the broadcast message includes at least a video timestamp corresponding to a time of a video stream displayed by an external display device, a server time of the processing server, and a response time; identifying, by a data identification module of the computing device, a presentation time based on a combination of the video timestamp, the response time, and a correspondence between the server time and a device time of the computing device; and emitting, by an audio emitting device of the computing device, the audio stream at a position in the audio stream based on the identified presentation time.

A system for synchronizing remotely played audio with a video display includes: a generation module of a processing server; a transmitting device of the processing server; a receiving device of the processing server configured to receive a video data file, wherein the video data file includes at least a video stream and an audio stream; and a decoding module configured to decode the audio stream from the received video data file, wherein the receiving device of the processing server is further configured to receive a video timestamp, wherein the video timestamp corresponds to a time of the video stream as being displayed by a display device, the generation module of the processing server is configured to generate a broadcast message, wherein the broadcast message includes at least the video timestamp, a server time of the processing server, and a response time, and the transmitting device of the processing server is configured to electronically transmit the generated broadcast message to one or more computing devices.

A system for emitting audio synchronized with remotely displayed video includes: a transmitting device of a computing device configured to electronically transmit a data request to a processing server, wherein the data request includes at least a video identifier; a receiving device of the computing device configured to receive an audio stream, and receive a broadcast message from the processing server, wherein the broadcast message includes at least a video timestamp corresponding to a time of a video stream displayed by an external display device, a server time of the processing server, and a response time; a data identification module of the computing device configured to identify a presentation time based on a combination of the video timestamp, the response time, and a correspondence between the server time and a device time of the computing device; and an audio emitting device of the computing device configured to emit the audio stream at a position in the audio stream based on the identified presentation time.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIGS. 1A and 1B are block diagrams illustrating a high level system architecture for the automatic synchronization of audio content to remotely display video in accordance with exemplary embodiments.

FIG. 2 is a block diagram illustrating the user device of the system of FIG. 1 for the automatic synchronization and emission of audio content to remotely displayed visual media in accordance with exemplary embodiments.

FIG. 3 is a block diagram illustrating the processing server of the system of FIG. 1 for the automatic synchronization of audio content with remotely displayed visual media in accordance with exemplary embodiments.

FIG. 4 is a flow diagram illustrating a process for the automatic synchronization of audio content with remotely displayed visual media in the system of FIG. 1 in accordance with exemplary embodiments.

FIG. 5 is a flow chart illustrating an exemplary method for synchronizing remotely played audio with a visual display in accordance with exemplary embodiments.

FIG. 6 is a flow chart illustrating an exemplary method for emitting audio synchronized with remotely displayed video in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Automatic Synchronization of Audio and Remotely Displayed Video

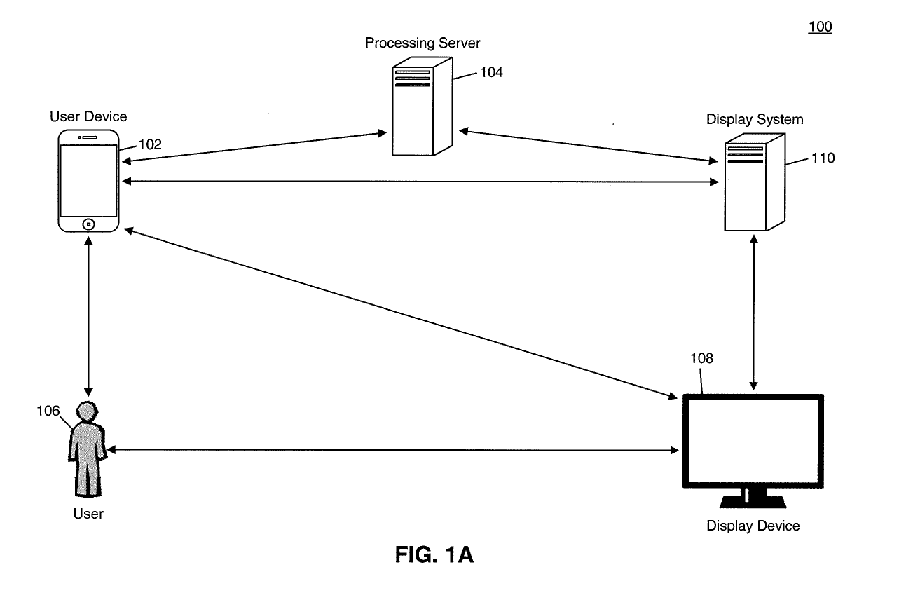

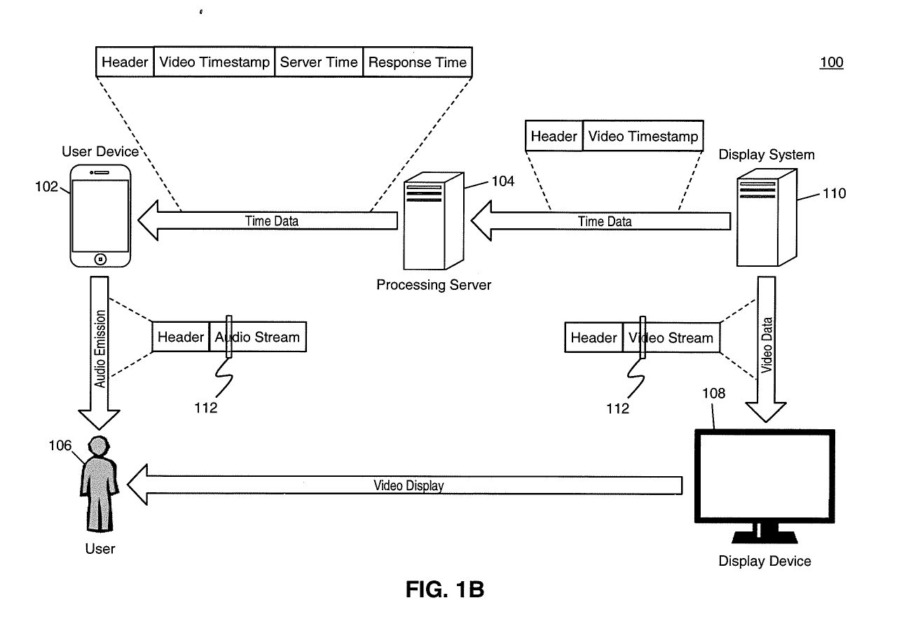

FIG. 1A illustrates a system 100 for the automatic synchronization of audio content being emitted by a user device 102 with a video or other visual media remotely displayed by a display device 108 that is separate from the user device 102. As discussed herein, “video” may refer to any type of visual media, including static visual media (e.g., an image), that is displayed via electronic means, which may be capable of being moved, animated, changed, or otherwise visually modified while being viewed by a user 106. FIG. 1B illustrates the system 100 including the transmission of data signals between components of the system 100 as indicated in the illustration in FIG. 1A and discussed herein.

The user device 102, discussed in more detail below, may be configured to emit audio to a user 106 thereof, which is automatically synchronized with a video being displayed by a separate display device 108 using the methods discussed herein. The user device 102 may be any type of computing device, such as a cellular phone, smart phone, smart watch, tablet computer, notebook computer, laptop computer, wearable computing device, implantable computing device, etc., that is specifically configured to perform the functions discussed herein, with speakers, ear buds or headphones or the like wired or wirelessly connected to the user device 102.

The system 100 may also include a processing server 104. The processing server 104, discussed in more detail below, may be configured to collect timing information with respect to the video being displayed by the display device 108 that may be utilized by the user device 102 in automatically synchronizing the audio content to the video display. The processing server 104 may be any type of computing device that has been specifically configured to perform the functions as discussed herein.

As part of the system 100, the processing server 104 may receive data regarding the video to be displayed as well as accompanying audio content. In some embodiments, the system 100 may include a display system 110, which may be a computing device or other suitable device that is interfaced or otherwise in communication with the display device 108 that provides data to the display device 108 corresponding to the video to be displayed. For instance, the display device 108 may be a monitor that is connected to the display system 110, which may be a laptop computer physically located in proximity of the monitor and interfaced therewith, such as via a physical cable, local area network, etc. In some instances, the display system 110 and display device 108 may be a single device, such as a laptop computer or a projector integrated with a computing device. The processing server 104 may receive the data regarding the video from the display system 110, or from other system or entity that is in communication therewith. For example, a third party entity may provide video data to display systems 110 for display, and may provide the data or data associated therewith to the processing server 104.

The data received by the processing server 104 may include at least a video data file that includes a video stream and an accompanying audio stream. In some embodiments, the accompanying audio stream may be a reference to an externally located audio file, which may be located and retrieved by the processing server 104. In some cases, the audio stream may be included in a separate audio file that accompanies the video data file. In some instances, the processing server 104 may receive a uniform resource locator (URL) that directs the processing server 104 to a video data file. For instance, in one example, the processing server 104 may be provided with a URL to an externally hosted video (e.g., a YouTube® video), where the processing server 104 may be configured to extract the video stream and audio stream from the location referred to by the URL. In some cases, the video may be streamed directly via the URL rather than the video stream being directed and stored locally in the processing server 104 or display system 110. In some instances, the audio may also, or alternatively, be streamed to the processing server 104.

In some embodiments, the processing server 104 may be provided with the video and accompanying audio data in a submission requesting that the video be displayed by the display device 108. For example, the processing server 104 may be used in the distribution of audio and visual content, such as described in more detail in U.S. patent application Ser. No. 14/250,768, entitled “System and Method for Distribution of Audio and Projected Visual Content,” by Alexander Vandoros, filed on Apr. 11, 2014, which is herein incorporated by reference in its entirety. In one example, an individual may submit a photo slideshow to the processing server 104 for display on the display device 108 with an accompanying song to be emitted, to celebrate the birthday of a user 106 that may pass by the display device 108 as a surprise to the user 106.

The processing server 104 may receive the video data file and may extract the audio stream therefrom or otherwise obtain the audio stream (e.g., as extracted from a separately accompanying audio file, as applicable). The display system 110 may instruct the display device 108 to display the video content. In cases where an individual may submit the video data with one or more criteria for display, the display system 110 may await such criteria to be fulfilled for display of the video on the display device 108 (e.g., awaiting a specific time on a specific day, such as when the targeted user 106 may be exposed to the display device 108). The display system 110 may cause the display device 108 to display the video content and may keep track of the current position 112 of the video being displayed. The display system 110 may regularly report the current position 112 of the video to the processing server 104 via an electronic transmission thereto using a suitable communication method and network, such as via a local area network, cellular communication network, the Internet, etc. The processing server 104 may receive the data and may store the positioning data for the video in a memory thereof. In some embodiments, the processing server 104 and the display system 110 may be a single device. In such embodiments, the processing server 104 may be configured to also perform functions of the display system 110 in addition to the functions discussed herein (e.g., the display and reporting of positioning of the video in addition to other functions discussed herein).

The processing server 104 may store the video data and its positioning data with a video identifier associated with the video. The video identifier may be a unique value that corresponds to the video being displayed, such as an identification number. In some instances, the video identifier may be identified by the processing server 104 upon receipt of new video data, and may be provided to the display system 110 along with the video. In other instances, the video data may be accompanied by its associated video identifier, and may be used by the processing server 104 accordingly. For example, a display device 108 may have a video identifier associated therewith, which may be provided to the processing server 104 with the video that is to be displayed on that display device 108.

As the video is being displayed on the display device 108, the user 106 may approach the display device 108 and view the video. While viewing the video, the user 106 may be interested in listening to accompanying audio content on their user device 102. Using the user device 102, the user 106 may identify the video being displayed via its video identifier. In one embodiment, the display device 108 may display the video identifier overlaid on the video or in proximity to the displayed video. In another embodiment, the display device 108 may include a separate display that may be used to display the video identifier. In some instances, the video identifier may be physically displayed on the display device 108. For instance, the video identifier may be unique to the display device 108 itself in cases where the display device 108 may only display a single video at a time, where the video identifier may be physically displayed on the display device 108. In such embodiments, the user 106 may manually enter the video identifier into the user device 102. In another embodiment, the video identifier may be encoded in a machine-readable code displayed on the display of the display device 108 or on the display device 108 itself. For example, the display device 108 may have a bar code or quick response (QR) code affixed thereto that is encoded with the video identifier, which may be read by the user device 102. In yet another embodiment, the display device 108 and/or display system 110 may electronically broadcast the video identifier using a suitable communication method, such as Bluetooth, near field communication, radio frequency, etc., which may be received by the user device 102. The video identifier can be broadcast through nearly any suitable low range signal, with the range optimally being proportional to the likely range of viewing of the display device 108 (e.g., measured in feet in a shopping mall, hundreds or even thousands of feet for a billboard adjacent a road, depending on size and viewing distance).

Once the user device 102 has received the video identifier, the user device 102 may electronically transmit the video identifier to the processing server 104 using a suitable communication network and method. The processing server 104 may then identify the video data that corresponds to the video identifier. The processing server 104 may identify the current position 112 of the video as reported by the display system 110 and provide the position to the user device 102. Along with the position, the processing server 104 may provide the current system time of the processing server 104, which may differ from the system time of the user device 102, as well as a response time. The response time may be indicative of the time it takes for the processing server 104 to receive the positioning data from the display system 110 and provide it to the user device 102, such as to compensate for latency due to communication. In some cases, the video position time provided to the user device 102 may be accompanied by the server time when the video position time was received from the display system 110. In other cases, the processing server 104 may update the video position time based on the current server time and the server time when the position time was received from the display system 110.

The user device 102 may receive the video position time, the system time of the processing server 104, as well as the response time. The user device 102 may then identify the proper time for the audio stream based on the received times. In some cases, the user device 102 may be configured to adjust its own system time based on the system time of the processing server 104, such as to provide for faster identification of the time for the audio stream. The inclusion of the response time may ensure that the audio stream is played at the correct time to compensate for any latency in processing time by the processing server 104 and communication latency between the display system 110 and the processing server 104 and the processing server 104 and the user device 102. In some cases, the user device 102 may identify a response time for communications between the processing server 104 and user device 102 based on its own communications data (e.g., a signal strength to a communication network through which the data is received, or a test signal return path timing). For example, the processing server 104 may indicate that the current position 112 of the video is exactly six minutes in, but where the response time is two seconds. The user device 102 may thus initiate emission of the audio stream at current position 112 of 6:02 into the stream, to compensate for the response time and thus match the video stream being displayed on the display device 108.

In some embodiments, the processing server 104 may be configured to electronically transmit the audio stream to the user device 102. In some such embodiments, the audio stream may be accompanied by the positioning data. In some cases, the processing server 104 may electronically transmit the entire data comprising the audio stream to the user device 102. In other cases, the audio stream may be streamed to the user device 102 such that it is played to the user while transmission is ongoing. In other such embodiments, the positioning data may be encoded in the audio stream, where the user device 102 may decode the positioning data. In other embodiments, the user device 102 may receive the audio stream from the display system 110 or from a third party computing system. For example, the display system 110 may broadcast the audio stream along with the video identifier (e.g., which may be encoded in the broadcast audio stream) for receipt by the user device 102. The user device 102 may receive the broadcast audio stream from the display system 110, and, using the positioning data supplied by the processing server 104, navigate to the proper time in the audio stream. The user device 102 may then emit the audio stream from the proper time, which has thus been automatically synchronized to the video being displayed by the display device 108. In some cases, the audio stream provided to the user device 102 may only include audio data starting at the current position of the video, as based on the video position time reported by the display system 110, such as to reduce the amount of data being transferred. In such cases, the response time may be adjusted accordingly, such as in instances where the response time may be lowered due to the smaller amount of data being transmitted.

As a result, the methods and systems discussed herein may enable a user device 102 to emit audio that is automatically synchronized to a video being displayed remotely on a display device 108 that is not interfaced with the user device 102. The processing server 104 utilizes positioning time reported by the display system 110 along with system time and response time information to identify the current position of the video being display when reported to the user device 102. The user device 102 utilizes this positioning data to navigate to the proper time in the audio stream that is associated with the remotely displayed video to ensure that the audio stream is emitted at the proper time for automatic synchronization to the video. As such, a user 106 may listen along to a video via their own personal user device 102 with ideal synchronization. As a result, video content may be displayed by display devices 108 that lack any audio emitting capabilities, and in locations and circumstances where the direct playing of audio may be unfeasible (e.g., a billboard) or inconvenient (e.g., a crowded street, museum, etc.).

### User Device

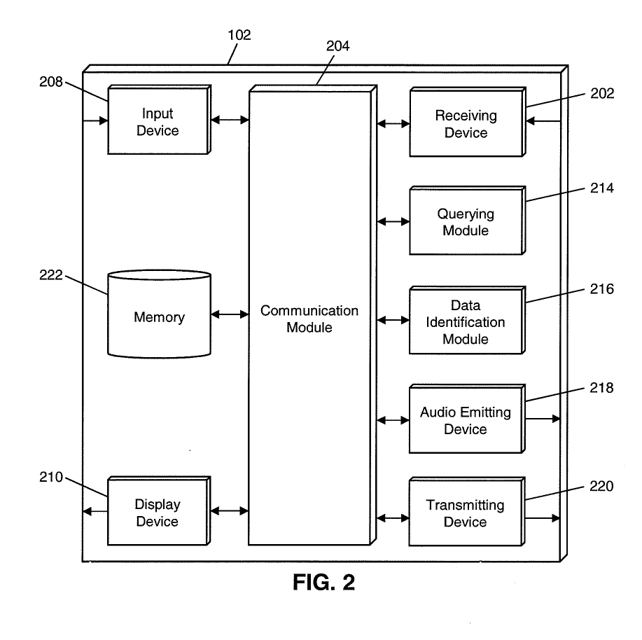

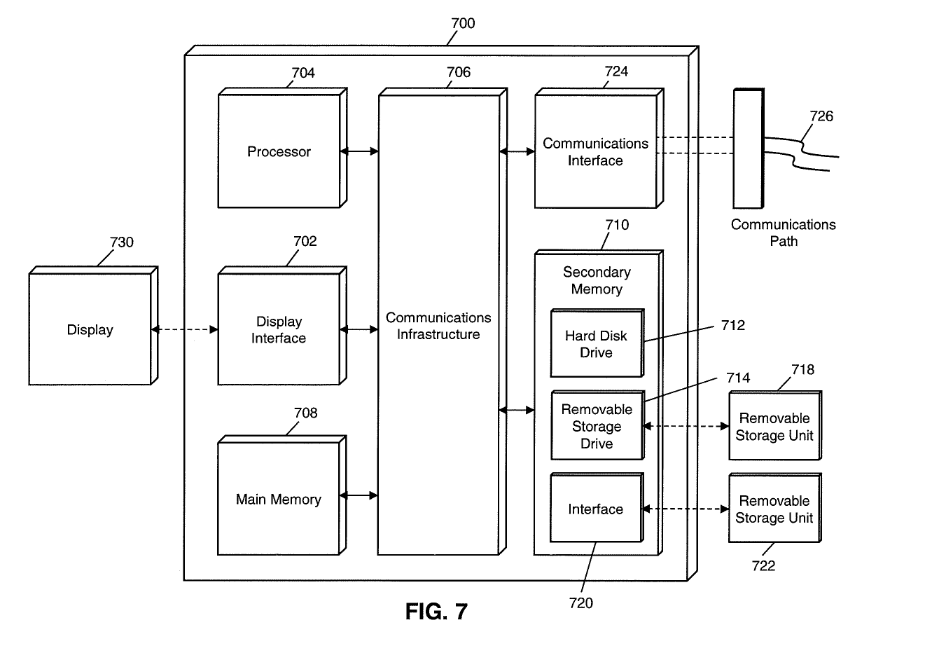

FIG. 2 illustrates an embodiment of a user device 102 in the system 100. It will be apparent to persons having skill in the relevant art that the embodiment of the user device 102 illustrated in FIG. 2 is provided as illustration only and may not be exhaustive to all possible configurations of the user device 102 suitable for performing the functions as discussed herein. For example, the computer system 700 illustrated in FIG. 7 and discussed in more detail below may be a suitable configuration of the user device 102.

The user device 102 may include a receiving device 202. The receiving device 202 may be configured to receive data over one or more networks via one or more network protocols. In some instances, the receiving device 202 may be configured to receive data from processing servers 104, display systems 110, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by processing servers 104, which may be superimposed or otherwise encoded with positioning data, which may include at least a current video position time, system time of the processing server 104, and response time. The receiving device 202 may also be configured to receive data signals that may be electronically transmitted by processing servers 104 or display systems 110, which may be superimposed or otherwise encoded with an audio stream. In some cases, the audio stream may be encoded with the positioning data. The receiving device 202 may also be configured to receive data signals electronically transmitted by display systems 110, which may be superimposed or otherwise encoded with a video identifier associated with a video being displayed by the display device 108 interfaced therewith.

The user device 102 may also include a communication module 204. The communication module 204 may be configured to transmit data between modules, engines, databases, memories, and other components of the user device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the user device 102 and external components of the user device 102, such as externally connected databases, display devices, input devices, etc. The user device 102 may also include a processing device. The processing device may be configured to perform the functions of the user device 102 discussed herein as will be apparent to persons having skill in the relevant art. In some embodiments, the processing device may include and/or be comprised of a plurality of engines and/or modules specially configured to perform one or more functions of the processing device, such as a querying module 214, data identification module 216, etc. As used herein, the term “module” may be software or hardware particularly programmed to receive an input, perform one or more processes using the input, and provides an output. The input, output, and processes performed by various modules will be apparent to one skilled in the art based upon the present disclosure.

The user device 102 may include a memory 222. The memory 222 may be configured to store data for use by the user device 102 in performing the functions discussed herein, such as public and private keys, symmetric keys, etc. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the user device 102 in the performance of the functions disclosed herein as will be apparent to persons having skill in the relevant art. In some embodiments, the memory 222 may be comprised of or may otherwise include a relational database that utilizes structured query language for the storage, identification, modifying, updating, accessing, etc. of structured data sets stored therein. The memory 222 may be configured to store an audio stream received by the receiving device 202 for playing, and may also be configured to store video identifiers, positioning data, a system time, and any other data that may be used by the user device 102 in performing the functions discussed herein.

The user device 102 may also include or be otherwise interfaced with one or more input devices 208. The input devices 208 may be internal to the user device 102 or external to the user device 102 and connected thereto via one or more connections (e.g., wired or wireless) for the transmission of data to and/or from. The input devices 208 may be configured to receive input from a user of the user device 102, which may be provided to another module or engine of the user device 102 (e.g., via the communication module 204) for processing accordingly. Input devices 208 may include any type of input device suitable for receiving input for the performing of the functions discussed herein, such as a keyboard, mouse, click wheel, scroll wheel, microphone, touch screen, track pad, camera, optical imager, etc. The input device 208 may be configured to, for example, receive a video identifier as input by a user 106, read a machine-readable code displayed on the display device 108, or listen to an audio signal emitted by the display system 110 (e.g., encoded with the video identifier, which may be emitted outside of the range of human hearing).

The user device 102 may also include or be otherwise interfaced with a display device 210. The display device 210 may be internal to the user device 102 or external to the user device 102 and connected thereto via one or more connections (e.g., wired or wireless) for the transmission of data to and/or from. The display device 210 may be configured to display data to a user of the user device 102. The display device 210 may be any type of display suitable for displaying data as part of the functions discussed herein, such as a liquid crystal display, light emitting diode display, thin film transistor display, capacitive touch display, cathode ray tube display, light projection display, etc. In some instances, the user device 102 may include multiple display devices 210. The display device 210 may be configured to, for example, display an interface to the user 106 for inputting a video identifier, displaying information accompanying the video being displayed, displaying the positioning information for the video, etc.

The user device 102 may include a querying module 214. The querying module 214 may be configured to execute queries on databases to identify information. The querying module 214 may receive one or more data values or query strings, and may execute a query string based thereon on an indicated database, such as the memory 222, to identify information stored therein. The querying module 214 may then output the identified information to an appropriate engine or module of the user device 102 as necessary. The querying module 214 may, for example, execute a query on the memory 222 to identify an audio stream for navigation to a position based on positioning data received by the receiving device 202.

The user device 102 may also include a data identification module 216. The data identification module 216 may be configured to identify data for use by the user device 102 in performing the functions thereof as discussed herein. For instance, the data identification module 216 may be configured to identify a time for navigation of an audio stream, herein referred to as a “presentation” time, which may be based on positioning data received by the receiving device 202. For instance, the data identification module 216 may be supplied with the video timestamp, the system time of the processing server 104, and the response time, and may identify the presentation time for the audio stream based thereon. The data identification module 216 may be configured to output identified data to another module or engine of the user device 102.

The user device 102 may also include an audio emitting device 218. The audio emitting device 218 may be configured to audibly emit audio (e.g., via a speaker) or to electronically transmit an audio signal for emission by a device interfaced with the user device 102 (e.g., headphones, an external speaker, etc.). The audio emitting device 218 may receive an audio stream and a presentation time as input, such as from the receiving device 202 and data identification module 216, respectively, and may emit the audio stream from the position of the presentation time for automatic synchronization of the audio stream to video being displayed by a display device 108.

The user device 102 may also include a transmitting device 220. The transmitting device 220 may be configured to transmit data over one or more networks via one or more network protocols. In some instances, the transmitting device 220 may be configured to transmit data to processing servers 104, display systems 110, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to processing servers 104 and display systems 110, which may be superimposed or otherwise encoded with a request for a video identifier, which may include data indicative of the display device 108 viewable by the user 106 of the user device 102 (e.g., a geographic location), which may be used in identification of the video identifier. The transmitting device 220 may also be configured to electronically transmit data signals to processing servers 104 that are superimposed or otherwise encoded with a request for positioning data, which may include at least a video identifier associated with a video being displayed by a display device 108 for which positioning data is requested. In some instances, the request may also include an indication as to whether or not the user device 102 requires the audio stream for the video. In some embodiments, the transmitting device 220 may be configured to electronically transmit data signals to display systems 110, which may be superimposed or otherwise encoded with a request for an audio stream.

### Processing Server

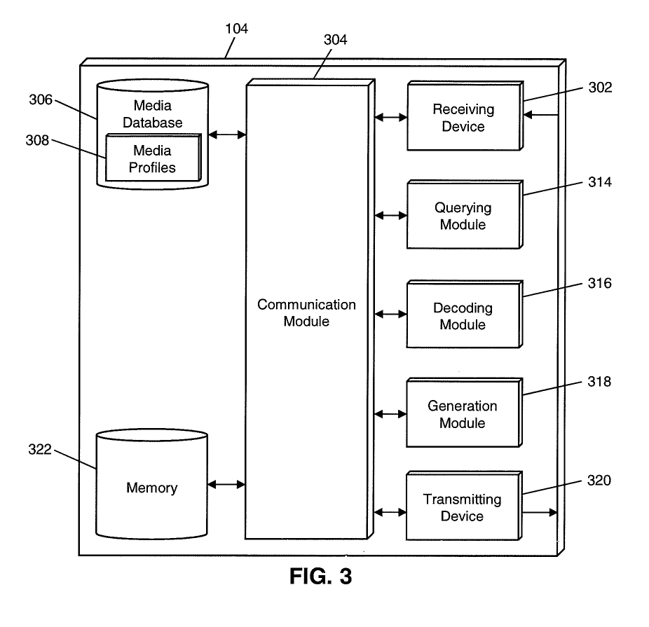

FIG. 3 illustrates an embodiment of a processing server 104 in the system 100. It will be apparent to persons having skill in the relevant art that the embodiment of the processing server 104 illustrated in FIG. 3 is provided as illustration only and may not be exhaustive to all possible configurations of the processing server 104 suitable for performing the functions as discussed herein. For example, the computer system 700 illustrated in FIG. 7 and discussed in more detail below may be a suitable configuration of the processing server 104.

The processing server 104 may include a receiving device 302. The receiving device 202 may be configured to receive data over one or more networks via one or more network protocols. In some instances, the receiving device 302 may be configured to receive data from computing devices 102, display systems 110, and other systems and entities via one or more communication methods, such as radio frequency, local area networks, wireless area networks, cellular communication networks, Bluetooth, the Internet, etc. In some embodiments, the receiving device 302 may be comprised of multiple devices, such as different receiving devices for receiving data over different networks, such as a first receiving device for receiving data over a local area network and a second receiving device for receiving data via the Internet. The receiving device 302 may receive electronically transmitted data signals, where data may be superimposed or otherwise encoded on the data signal and decoded, parsed, read, or otherwise obtained via receipt of the data signal by the receiving device 302. In some instances, the receiving device 302 may include a parsing module for parsing the received data signal to obtain the data superimposed thereon. For example, the receiving device 302 may include a parser program configured to receive and transform the received data signal into usable input for the functions performed by the processing device to carry out the methods and systems described herein.

The receiving device 302 may be configured to receive data signals electronically transmitted by computing devices 102, which may be superimposed or otherwise encoded with requests for positioning data, which may include a video identifier and, in some instances, may include an indication as to whether or not an audio stream is requested. The receiving device 302 may also be configured to receive data signals electronically transmitted by display systems 110 and other systems that may be superimposed or otherwise encoded with video data files, which may include video streams and associated audio streams. The receiving device 302 may also be configured to receive data signals electronically transmitted by display systems that are superimposed or otherwise encoded with positioning data, including at least a video timestamp for the position of the video being displayed. In some cases, the video timestamp may be accompanied by a system time of the display system 110.

The processing server 104 may also include a communication module 304. The communication module 304 may be configured to transmit data between modules, engines, databases, memories, and other components of the processing server 104 for use in performing the functions discussed herein. The communication module 304 may be comprised of one or more communication types and utilize various communication methods for communications within a computing device. For example, the communication module 304 may be comprised of a bus, contact pin connectors, wires, etc. In some embodiments, the communication module 304 may also be configured to communicate between internal components of the processing server 104 and external components of the processing server 104, such as externally connected databases, display devices, input devices, etc. The processing server 104 may also include a processing device. The processing device may be configured to perform the functions of the processing server 104 discussed herein as will be apparent to persons having skill in the relevant art. In some embodiments, the processing device may include and/or be comprised of a plurality of engines and/or modules specially configured to perform one or more functions of the processing device, such as a querying module 314, decoding module 316, generation module 318, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 104 may include a media database 306. The media database 306 may be configured to store a plurality of media profiles 308 using a suitable data storage format and schema. The media database 306 may be a relational database that utilizes structured query language for the storage, identification, modifying, updating, accessing, etc. of structured data sets stored therein. Each media profile 308 may be a structured data set configured to store data related to visual media, which may include at least a received video data file and/or its constituent video and audio streams, as well as the video identifier associated therewith. A media profile 308 may also include the positioning data most recently received for the corresponding video as it is being displayed.

The processing server 104 may include a querying module 314. The querying module 314 may be configured to execute queries on databases to identify information. The querying module 314 may receive one or more data values or query strings, and may execute a query string based thereon on an indicated database, such as the media database 306, to identify information stored therein. The querying module 314 may then output the identified information to an appropriate engine or module of the processing server 104 as necessary. The querying module 314 may, for example, execute a query on the media database 306 to identify a media profile 308 that includes a video identifier provided by the user device 102, for the identification of positioning data stored therein to provide to the user device 102.

The processing server 104 may also include a decoding module 316. The decoding module 316 may be configured to decode video data files to extract video and audio streams included therein for use by the processing server 104 as discussed herein. The decoding module 316 may receive a video data file as input, may extract the video and audio streams from the video data file, and may output the extracted streams to other modules or engines of the processing server 104. In instances where a URL is supplied to the processing server 104, the decoding module 316 may be configured to navigate an Internet or other web browsing application program to the URL and decode video and/or audio streams from the location.

The processing server 104 may also include a generation module 318. The generation module 318 may be configured to generate data for use by the processing server 104 in performing the functions discussed herein. The generation module 318 may receive an instruction as input, may generate data as instructed, and may output the generated data to another module or engine of the processing server 104. For example, the generation module 318 may be configured to generate a broadcast message that includes at least a system time, a video timestamp, and a response time, for electronic transmission to a user device 102. In some embodiments, the generation module 318 may also be configured to identify the response time, which may be based on communication latencies and processing times by the components of the processing server 104, for inclusion in the positioning data to be included in the broadcast message. In some instances, the generation module 318 may be configured to encode the broadcast message in an audio stream for transmission to a user device 102.

The processing server 104 may also include a transmitting device 320. The transmitting device 320 may be configured to transmit data over one or more networks via one or more network protocols. In some instances, the transmitting device 320 may be configured to transmit data to computing devices 102, display systems 110, and other entities via one or more communication methods, local area networks, wireless area networks, cellular communication, Bluetooth, radio frequency, the Internet, etc. In some embodiments, the transmitting device 320 may be comprised of multiple devices, such as different transmitting devices for transmitting data over different networks, such as a first transmitting device for transmitting data over a local area network and a second transmitting device for transmitting data via the Internet. The transmitting device 320 may electronically transmit data signals that have data superimposed that may be parsed by a receiving computing device. In some instances, the transmitting device 320 may include one or more modules for superimposing, encoding, or otherwise formatting data into data signals suitable for transmission.

The transmitting device 320 may be configured to electronically transmit data signals to display systems 110 that are superimposed or otherwise encoded with video identifiers, which, in some instances, may be accompanied by requests for positioning data. The transmitting device 320 may also be configured to electronically transmit data signals to user devices 102, which may be superimposed or otherwise encoded with a broadcast message generated by the generation module 318 that includes the positioning data. In some instances, the broadcast message may be encoded in an audio signal that is transmitted to the user device 102.

The processing server 104 may include a memory 322. The memory 322 may be configured to store data for use by the processing server 104 in performing the functions discussed herein, such as public and private keys, symmetric keys, etc. The memory 322 may be configured to store data using suitable data formatting methods and schema and may be any suitable type of memory, such as read-only memory, random access memory, etc. The memory 322 may include, for example, encryption keys and algorithms, communication protocols and standards, data formatting standards and protocols, program code for modules and application programs of the processing device, and other data that may be suitable for use by the processing server 104 in the performance of the functions disclosed herein as will be apparent to persons having skill in the relevant art. In some embodiments, the memory 322 may be comprised of or may otherwise include a relational database that utilizes structured query language for the storage, identification, modifying, updating, accessing, etc. of structured data sets stored therein.

### Process for Automatic Synchronization of Audio to Remotely Displayed Video

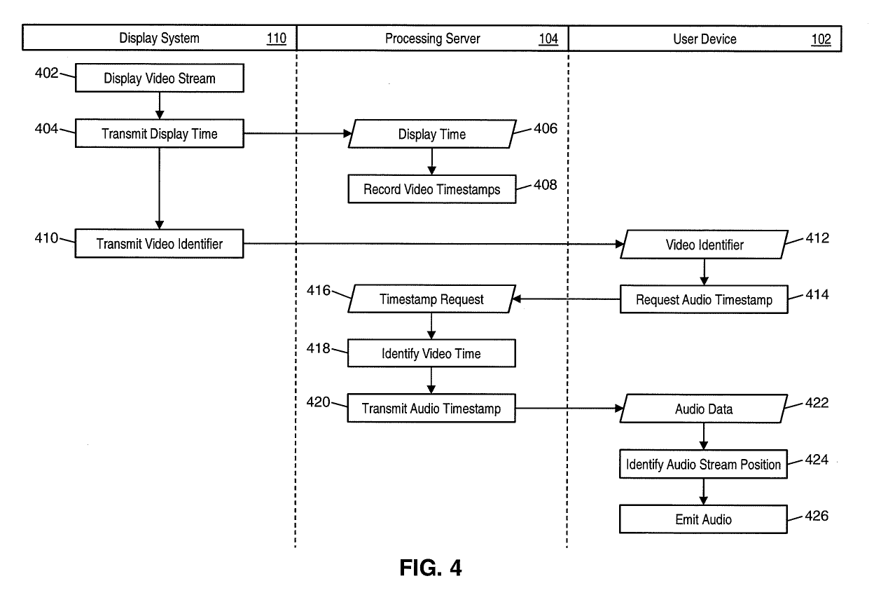

FIG. 4 illustrates a process 400 for the automatic synchronization of audio emitted by the user device 102 of the system 110 with video being remotely displayed by the display device 108 that is not interfaced with the user device 102.

In step 402, the display system 110 may electronically transmit a video stream to the display device 108 for display thereof to the user 106. In step 404, the display system 110 may identify a video timestamp indicative of the current position of the video stream and electronically transmit the video timestamp to the processing server 104 using a suitable communication method and network. In some embodiments, the video timestamp may be accompanied by the video identifier associated with the video. In step 406, the receiving device 302 of the processing server 102 may receive the video timestamp, as well as the video identifier, as applicable. In step 408, the querying module 314 of the processing server 104 may execute a query on the media database 306 to store the video timestamp in the media profile 308 associated with the video (e.g., identified via the video identifier).

In step 410, the display system 110 may electronically transmit the video identifier associated with the video to the user device 102. In some embodiments, the display system 110 may broadcast the video identifier via a suitable communication method for receipt by any listening computing device. In other embodiments, the display system 110 may display the video identifier in a manner suitable for reading by the user device 102, such as encoded in a machine-readable code displayed by the display system 110 and/or the interlaced display device 108. In step 412, the receiving device 202 of the user device 102 may receive the video identifier.

In step 414, the transmitting device 220 of the user device 102 may electronically transmit a request for an audio timestamp to the processing server 104 using a suitable communication network and method. The request may include at least the video identifier received by the user device 102 in step 412. In step 416, the receiving device 302 of the processing server 104 may receive the request from the user device 102 and may identify the video identifier included therein. In step 418, the querying module 314 of the processing server 104 may execute a query on the media database 306 to identify the media profile 308 stored therein that includes the video identifier and identify the video timestamp stored therein. In step 420, the transmitting device 320 of the processing server 104 may electronically transmit an audio timestamp, which may be comprised of the video timestamp, the system time of the processing server 104, and a response time, which may be identified by the generation module 318 and be based on the processing time of the processing server 104 and the communication network and methods used for communications with the display system 110 and/or the user device 102.

In step 422, the receiving device 202 of the user device 102 may receive the audio timestamp data from the processing server 104. In step 424, the data identification module 216 of the user device 102 may identify the presentation time for the audio stream based on the received data. In some cases, the identification may include a comparison of the system time of the user device 102 with the system time of the processing server 104. In step 426, the audio emitting device 218 of the user device 102 may emit the audio stream navigated to the identified presentation time, for automatic synchronization thereof to the video being displayed by the display device 108.

Exemplary Method for Synchronizing Remotely Played Audio with a Video Display

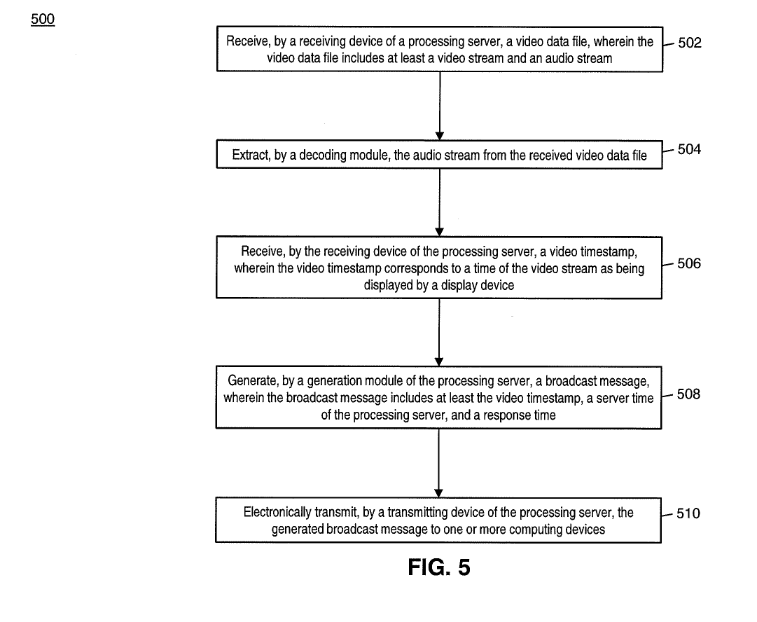

FIG. 5 illustrates a method 500 for the automatic synchronization of an audio streaming being remotely played by a computing device with video being displayed by a separate video display device.

In step 502, a video data file may be received by a receiving device (e.g., the receiving device 302) of a processing server (e.g., the processing server 104), wherein the video data file includes at least a video stream and an audio stream. In step 504, the audio stream may be extracted from the received video data file by a decoding module (e.g., the decoding module 316) of the processing server. In step 506, a video timestamp may be received by the receiving device of the processing server, wherein the video timestamp corresponds to a time of the video stream as being displayed by a display device (e.g., the display device 108).

In step 508, a broadcast message may be generated by a generation module (e.g., the generation module 318) of the processing server, wherein the broadcast message includes at least the video timestamp, a server time of the processing server, and a response time. In step 510, the generated broadcast message may be electronically transmitted by a transmitting device (e.g., the transmitting device 320) of the processing server to one or more computing devices (e.g., user devices 102).

In one embodiment, the method 500 may further include receiving, by the receiving device of the processing server, a data request from the one or more computing devices, wherein the generated broadcast message is electronically transmitted in response to the received data request. In some embodiments, the response time may correspond to a length of time elapsed between receiving the video timestamp and electronically transmitting the broadcast message. In one embodiment, the broadcast message may be encoded in the audio stream to be electronically transmitted to the one or more computing devices.

Exemplary Method for Emitting Audio Synchronized with Remotely Displayed Video

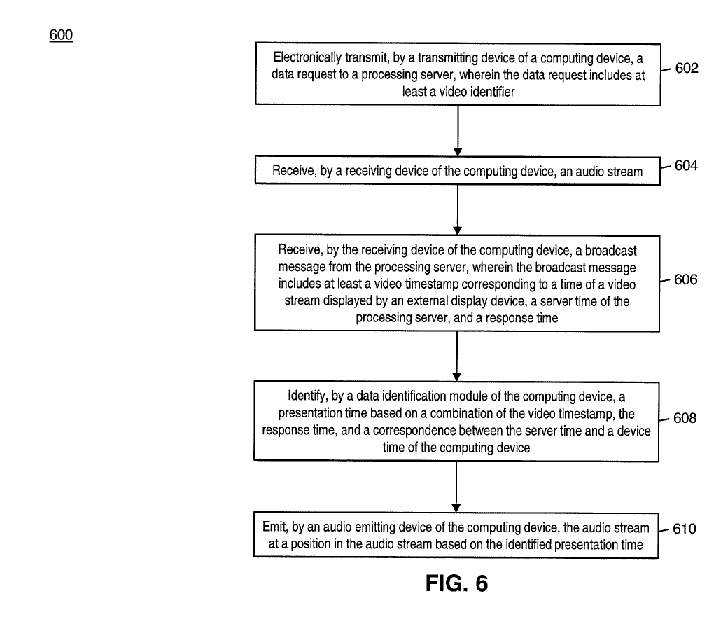

FIG. 6 illustrates a method 600 for the emission of audio on a computing device that is automatically synchronized to video being remotely displayed on a separate display device.

In step 602, a data request may be electronically transmitted by a transmitting device (e.g., the transmitting device 220) of a computing device (e.g., the user device 102) to a processing server (e.g., the processing server 104), wherein the data request includes at least a video identifier. In step 604, an audio stream may be received by a receiving device (e.g., the receiving device 202) of the computing device. In step 606, a broadcast message may be received by the receiving device of the computing device from the processing server, wherein the broadcast message includes at least a video timestamp corresponding to a time of a video stream displayed by an external display device (e.g., the display device 108), a server time of the processing server, and a response time.

In step 608, a presentation time may be identified by a data identification module (e.g., the data identification module 216) of the computing device based on a combination of the video timestamp, the response time, and a correspondence between the server time and a device time of the computing device. In step 610, the audio stream may be emitted by an audio emitting device (e.g., the audio emitting device 218) of the computing device at a position in the audio stream based on the identified presentation time.

In one embodiment, the broadcast message may be encoded in the received audio stream. In some embodiments, the device time of the computing device may be adjusted based on the server time. In one embodiment, the method 600 may further include receiving, by the receiving device of the computing device, the video identifier from an external computing system (e.g., the display system 110) prior to electronic transmission of the data request.

### Computer System Architecture

FIG. 7 illustrates a computer system 700 in which embodiments of the present disclosure, or portions thereof, may be implemented as computer-readable code. For example, the computing device 102 and processing server 104 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for automatic synchronization of emitted audio with remotely displayed video content. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for synchronizing remotely played audio with a video display, comprising:
receiving, by a receiving device of a processing server, a video data file, wherein the video data file includes at least a video stream and an audio stream;
extracting, by the processing server, the audio stream from the received video data file;
receiving, by the receiving device of the processing server, a video timestamp, wherein the video timestamp corresponds to a time of the video stream as being displayed by a display device;
generating, by the processing server, a broadcast message, wherein the broadcast message includes at least the video timestamp, a server time of the processing server, and a response time; and
electronically transmitting, by a transmitting device of the processing server, the generated broadcast message to at least two computing devices configured to generate an adjusted audio stream using at least the server time and the response time included in the generated broadcast message.

2. The method of claim 1, further comprising:
receiving, by the receiving device of the processing server, a data request from the one or more computing devices, wherein
the generated broadcast message is electronically transmitted in response to the received data request.

3. The method of claim 1, wherein the response time corresponds to a length of time elapsed between receiving the video timestamp and electronically transmitting the broadcast message.

4. The method of claim 1, wherein the broadcast message is encoded in the audio stream to be electronically transmitted to the one or more computing devices.

5. A method for emitting audio synchronized with remotely displayed video, comprising:
electronically transmitting, by a transmitting device of a computing device, a data request to a processing server, wherein the data request includes at least a video identifier;
receiving, by a receiving device of the computing device, an audio stream;
receiving, by the receiving device of the computing device, a broadcast message transmitted by the processing server to two or more computing devices, wherein the broadcast message includes at least a video timestamp corresponding to a time of a video stream displayed by an external display device, a server time of the processing server, and a response time;
identifying, by the computing device, a presentation time based on a combination of the video timestamp, the response time, and a correspondence between the server time and a device time of the computing device; and
emitting, by an audio emitting device of the computing device, the audio stream at a position in the audio stream based on the identified presentation time.

6. The method of claim 5, wherein the broadcast message is encoded in the received audio stream.

7. The method of claim 5, wherein the device time of the computing device is adjusted based on the server time.

8. The method of claim 5, further comprising:
receiving, by the receiving device of the computing device, the video identifier from an external computing system prior to electronic transmission of the data request.

9. A system for synchronizing remotely played audio with a video display, comprising:
a transmitting device of a processing server; and
a receiving device of the processing server configured to receive a video data file, wherein the video data file includes at least a video stream and an audio stream, wherein
the processing server is configured to decode the audio stream from the received video data file,
the receiving device of the processing server is further configured to receive a video timestamp, wherein the video timestamp corresponds to a time of the video stream as being displayed by a display device,
the processing server is further configured to generate a broadcast message, wherein the broadcast message includes at least the video timestamp, a server time of the processing server, and a response time, and
the transmitting device of the processing server is configured to electronically transmit the generated broadcast message to at least two computing devices configured to generate an adjusted audio stream using at least the server time and the response time included in the generated broadcast message.

10. The system of claim 9, wherein
the receiving device of the processing server is further configured to receive a data request from the one or more computing devices, and
the generated broadcast message is electronically transmitted in response to the received data request.

11. The system of claim 9, wherein the response time corresponds to a length of time elapsed between receiving the video timestamp and electronically transmitting the broadcast message.

12. The system of claim 9, wherein the broadcast message is encoded in the audio stream to be electronically transmitted to the one or more computing devices.

13. A system for emitting audio synchronized with remotely displayed video, comprising:
an audio emitting device of a computing device;
a transmitting device of the computing device configured to electronically transmit a data request to a processing server, wherein the data request includes at least a video identifier; and
a receiving device of the computing device configured to
receive an audio stream, and
receive a broadcast message transmitted by the processing server to at least two computing devices, wherein the broadcast message includes at least a video timestamp corresponding to a time of a video stream displayed by an external display device, a server time of the processing server, and a response time wherein
the computing device is configured to identify a presentation time based on a combination of the video timestamp, the response time, and a correspondence between the server time and a device time of the computing device, and
the audio emitting device of the computing device is configured to emit the audio stream at a position in the audio stream based on the identified presentation time.

14. The system of claim 13, wherein the broadcast message is encoded in the received audio stream.

15. The system of claim 13, wherein the device time of the computing device is adjusted based on the server time.

16. The system of claim 13, wherein the receiving device of the computing device is further configured to receive the video identifier from an external computing system prior to electronic transmission of the data request.
